(19) United States
(12) Patent Application Publication
(10) Pub. No.: US 2014/0040264 A1
(43) Pub. Date: Feb. 6, 2014

(54) METHOD FOR ESTIMATION OF INFORMATION FLOW IN BIOLOGICAL NETWORKS

(71) Applicants: Vinay Varadan, New York, NY (US); Prateek Mittal, Champaign, IL (US); Sitharthan Kamalakaran, Pelham, NY (US); Nevenka Dimitrova, Pelham Manor, NY (US); Angel Janevski, New York, NY (US); Nilanjana Banerjee, Armonk, NY (US)

(72) Inventors: Vinay Varadan, New York, NY (US); Prateek Mittal, Champaign, IL (US); Sitharthan Kamalakaran, Pelham, NY (US); Nevenka Dimitrova, Pelham Manor, NY (US); Angel Janevski, New York, NY (US); Nilanjana Banerjee, Armonk, NY (US)

(73) Assignee: Hgh Tech Campus, Eindhoven (NL)

(21) Appl. No.: 13/983,651

(22) PCT Filed: Jan. 30, 2012
(86) PCT No.: PCT/IB2012/050405

§ 371 Date: Oct. 9, 2013

Related U.S. Application Data
(60) Provisional application No. 61/439,414, filed on Feb. 4, 2011.

(51) Int. Cl. G06F 19/00

(52) U.S. Cl. CPC G06F 19/324
USPC 707/737

(57) ABSTRACT

The present invention relates to a method for stratifying a patient into a clinically relevant group comprising the identification of the probability of an alteration within one or more sets of molecular data from a patient sample in comparison to a database of molecular data of known phenotypes, the inference of the activity of a biological network on the basis of the probabilities, the identification of a network information flow probability for the patient via the probability of interactions in the network, the creation of multiple instances of network information flow for the patient sample and the calculation of the distance of the patient from other subjects in a patient database using multiple instances of the network information flow. The invention further relates to a biomedical marker or group of biomedical markers associated with a high likelihood of responsiveness of a subject to a cancer therapy wherein the biomedical marker or group of biomedical markers comprises altered biological pathway markers, as well as to an assay for detecting, diagnosing, graduating, monitoring or prognosticating a medical condition, or for detecting, diagnosing, monitoring or prognosticating the responsiveness of a subject to a therapy against said medical condition, in particular ovarian cancer. Furthermore, a corresponding clinical decision support system is provided.

### FIELD OF THE INVENTION

The present invention relates to a method for stratifying a patient into a clinically relevant group comprising the identification of the probability of an alteration within one or more sets of molecular data from a patient sample in comparison to a database of molecular data of known phenotypes, the inference of the activity of a biological network on the basis of the probabilities, the identification of a network information flow probability for the patient via the probability of interactions in the network, the creation of multiple instances of network information flow for the patient sample and the calculation of the distance of the patient from other subjects in a patient database using multiple instances of the network information flow. The invention further relates to a biomedical marker or group of biomedical markers associated with a high likelihood of responsiveness of a subject to a cancer therapy wherein the biomedical marker or group of biomedical markers comprises altered biological pathway markers, as well as to an assay for detecting, diagnosing, graduating, monitoring or prognosticating a medical condition, or for detecting, diagnosing, monitoring or prognosticating the responsiveness of a subject to a therapy against said medical condition, in particular ovarian cancer. Furthermore, a corresponding clinical decision support system is provided.

### BACKGROUND OF THE INVENTION

Several diseases, in particular cancerous diseases, are complex and involve the alteration of multiple gene functions or underlying cellular processes. These diseases constitute severe challenges to clinicians, who struggle for reliable stratification approaches with high sensitivity and specificity. One possibility of improving the stratification process is based on the use of molecular profiles, which are known to correspond to different clinically relevant groups. These profiles are often used for high throughput analyses through the statistical selection of a set of features, which jointly differentiates between clinically relevant classes of patients. Vaske et al., 2010, Bioinformatics, 26(12): i237-i245, for example, provide, a method for the inference of patient-specific biological pathway activities from multi-dimensional cancer genomics data using the Paradigm algorithm. However, the molecular signatures discovered so far typically do not capture the underlying cellular mechanisms and the high throughput and pathway-recognition approaches do not sufficiently capture how genes or proteins interact inside the cell and are therefore limited in their ability to reliably stratify patients.

There is, thus, a need for improved diagnostic tools enabling the clinician to use high-throughput data to stratify patients, in particular cancer patients.

### SUMMARY OF THE INVENTION

The present invention addresses this need and provides means and methods, which implement an enhanced recognition of cellular interactions, and thus allow an improved stratification of patients into clinically relevant groups. The above objective is in particular accomplished by a method for stratifying a patient into a clinically relevant group, comprising the steps of:

obtaining datasets comprising one or more sets of molecular data from a patient sample;

identifying the probability of an alteration within the one or more sets of molecular data in comparison to a database of molecular data of known phenotypes, preferably molecular data of the expression of one or more of the patient's genes;

inferring the activity of a biological network on the basis of said probabilities;

identifying a network information flow probability for said patient via the probability of interactions in said network based on said probability of altered molecular data;

creating multiple instances of network information flow for said patient sample by sampling from a full interaction probability distribution;

calculating the distance of said patient from other subjects in a patient database using the multiple instances of network information flow; and

assigning said patient to a clinically relevant group based on the outcome of the previous step.

This method is based on the use of biological knowledge captured as biological networks which is overlaid with alterations or alteration levels, e.g. activity levels of genes, copy numbers etc., as measured from multiple molecular modalities in a patient sample. The method thus advantageously allows to explicitly capture network alteration or activity levels in patients and to use these network alteration or activity levels to differentiate one patient from another. Since cells in a diseased tissue, in particular tumorous cells, process internal and environmental information using such networks, the method is better suited to capture a huge variety of cellular phenotypes than existing methods. It is therefore able to stratify patients into clinically relevant groups very accurately.

In a preferred embodiment of the present invention, the molecular data comprise data on nonsense mutations, single nucleotide polymorphisms (SNP), copy number variations (CNV), splicing variations, variations of a regulatory sequence, small deletions, small insertions, small indels, gross deletions, gross insertions, complex genetic rearrangements, inter chromosomal rearrangements, intra chromosomal rearrangements, loss of heterozygosity, insertion of repeats, deletion of repeats, DNA methylation, histone methylation or acetylation states, gene and/or non-coding RNA expression and/or chromatin precipitation data revealing DNA binding sites or regions.

In a further preferred embodiment said molecular data may be obtained by genome sequencing, immunohistochemistry, FISH, PCR-techniques and/or microarray-techniques.

In another preferred embodiment said comparison to a database of molecular data of known phenotypes is a comparison to a biological annotation database, a pathway database, a database on biological processes and/or a database on biological functions. In a particularly preferred embodiment said biological annotation database is the National Cancer Institute Pathway interaction database, the KEGG pathway database, the BioCarta database, the Panther database, the Reactome database, and/or the DAVID database.

In another preferred embodiment said probability of an alteration within the one or more sets of molecular data is identified by estimating altered expression levels of individual genes in the network by integrating said molecular data using a probabilistic graphical model framework. In a particularly preferred embodiment of the present invention said probabilistic graphical model framework is a factor graphs framework.

In another preferred embodiment said probability of an alteration within the one or more sets of molecular data is identified by estimating altered copy number levels, altered methylation states, or altered gene function due to mutations of genomic loci or genomic regions in the network by integrating said molecular data using a probabilistic graphical model framework, preferably factor graphs.

In yet another preferred embodiment of the present invention said interactions are interactions for genes or genomic loci with molecular alterations. In a particularly preferred embodiment said interactions are interactions for genes or genomic loci belonging to biological networks as defined in a pathway database.

In a further preferred embodiment of the present invention said creation of multiple instances of network information flow is used for the generation of a distribution of sample information flow vectors, representing the information flow in a network for the examined patient.

In another preferred embodiment of the present invention said distance of said patient from other subjects is calculated as the average of pairwise distance of information flow vectors in a given network.

In a particularly preferred embodiment said pairwise distance of information flow vectors is calculated as the Euclidean distance between the information flow vectors in a given network, or as a weighted Euclidean distance, wherein the weights for each entry in the information flow vector are proportional to the depth of that interaction in a given network.

In a further preferred embodiment of the present invention said assignment of said patient to a clinically relevant group is performed with a clustering algorithm based on the pairwise distances of said patient with one, more or all subjects in a patient database.

In yet another preferred embodiment of the present invention said patient database is a disease related database. Particularly preferred is a cancer disease related database.

In another preferred embodiment of the present invention said clinically relevant group is associated with a cancerous disease, or with the likelihood of recurrence of a cancerous disease in a subject after a therapy. In a particularly preferred embodiment of the present invention said cancerous disease is ovarian cancer, breast cancer, or prostate cancer.

In yet another preferred embodiment of the present invention said clinically relevant group is associated with the likelihood of responsiveness of a subject to a therapy comprising one or more platinum based drugs.

In another aspect the present invention relates to a biomedical marker or group of biomedical markers associated with a high likelihood of responsiveness of a subject to a cancer therapy, wherein said biomedical marker or group of biomedical markers comprises at least 3, 4, 5, 6, 7, 8, 9, 10, 11, 12, 13 or all markers selected from an altered endothelin pathway, an altered ceramide signaling pathway, an altered rapid glucocorticoid signaling pathway, an altered paxilin independent a4b1 and a4b7 pathway, an altered osteopontin pathway, an altered IL6 signaling pathway, an altered telomerase pathway, an altered JNK signaling pathway in the CD4+TCR pathway, an altered PLK2- and PLK4-pathway, an altered EPO-signaling pathway, an altered p53-pathway, an altered VEGFR1- and VEGFR-2 signaling pathway, an altered VEGFR1-specific pathway, and an altered syndecan-1 signaling pathway, indicated in Table 1. In a preferred embodiment, said cancer therapy is a platinum based cancer therapy.

In another aspect the present invention relates to an assay for detecting, diagnosing, graduating, monitoring or prognosticating a medical condition, or for detecting, diagnosing, monitoring or prognosticating the responsiveness of a subject to a therapy against said medical condition, comprising at least the steps of

(a) testing in a sample obtained from a subject for the alteration of a stratifying biomedical marker or group of biomedical markers as defined herein above;

(b) testing in a control sample for alterations of the same marker or group of markers as in (a);

(c) determining the difference in alterations of markers of steps (a) and (b); and

(d) deciding on the presence or stage of a medical condition or the responsiveness of a subject to a therapy against said medical condition based on the results obtained in step (c).

In a preferred embodiment said medical condition is cancer, more preferably ovarian cancer.

In yet another aspect the present invention relates to a clinical decision support system comprising:

an input for providing datasets comprising one or more sets of molecular data from a patient;

a computer program product for enabling a processor to carry out a method according to the present invention as defined herein above or below, and a computer program product for quantifying the degree of alteration of information flow of a biological network in said patient; and

an output for outputting the assignment of a patient to a clinically relevant group.

In a preferred embodiment of the present invention said assignment of a patient to a clinically relevant groups is visualized in the context of the information flow in the networks and other clinically relevant groups or healthy subjects. In a further preferred embodiment said assignment of a patient to a clinically relevant groups is visualized in the context of the information flow in the networks and other clinically relevant groups and healthy subjects.

### BRIEF DESCRIPTION OF THE DRAWINGS

FIG. 1 provides an overview over a clinical decision support system and the underlying methodology according to the present invention, using multi-modality high-throughput molecular profiling data from a single patient in the context of specific biological networks or pathways.

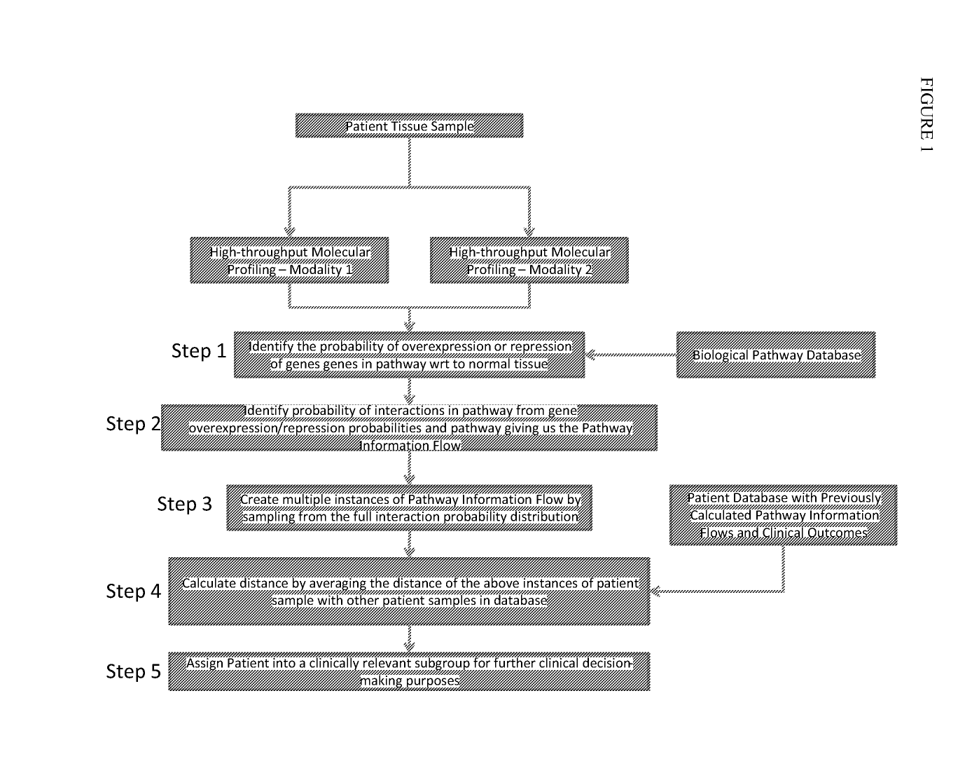

FIG. 2 illustrates an interaction between factors in a biological network. The Figure shows the example of an interaction of genes in a biological pathway

FIG. 3 shows a heatmap of the network information flow vectors of multiple patients based on a particular biological pathway. The network information flow vectors have been clustered based on their pairwise distances to form two major clusters or groups of patients. The color at any given pixel in the heatmap indicates the average of the multiple instances of the information flow at a particular node of the biological pathway for the given patient. The darker the color, the higher the average of the information flow at that location in the pathway.

FIG. 4 shows the Platinum-Free survival curves of the two groups of patients identified based on the clustering in FIG. 3. As can be seen, the survival curves corresponding to the two groups of patients are significantly different from each other. The p-value, which is the probability that such a separation in survival curves is purely by chance, is calculated as 0.021, which indicates that the survival curve difference seen in the figure is statistically significant.

### DETAILED DESCRIPTION OF EMBODIMENTS

The inventors have developed means and methods, which implement an enhanced recognition of cellular interactions, and thus allow an improved stratification of patients into clinically relevant groups.

Although the present invention will be described with respect to particular embodiments, this description is not to be construed in a limiting sense.

Before describing in detail exemplary embodiments of the present invention, definitions important for understanding the present invention are given.

As used in this specification and in the appended claims, the singular forms of “a” and “an” also include the respective plurals unless the context clearly dictates otherwise.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%.

It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In case the terms “first”, “second”, “third” or “(a)”, “(b)”, “(c)”, “(d)” etc. relate to steps of a method or use there is no time or time interval coherence between the steps, i.e. the steps may be carried out simultaneously or there may be time intervals of seconds, minutes, hours, days, weeks, months or even years between such steps, unless otherwise indicated in the application as set forth herein above or below.

It is to be understood that this invention is not limited to the particular methodology, protocols, algorithms, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As has been set out above, the present invention concerns in one aspect a method for stratifying a patient into a clinically relevant group, comprising the steps of:

obtaining datasets comprising one or more sets of molecular data from a patient sample;

identifying the probability of an alteration within the one or more sets of molecular data in comparison to a database of molecular data of known phenotypes, preferably molecular data of the expression of one or more of the patient's genes;

inferring the activity of a biological network on the basis of said probabilities;

identifying a network information flow probability for said patient via the probability of interactions in said network based on said probability of altered molecular data;

creating multiple instances of network information flow for said patient sample by sampling form a full interaction probability distribution;

calculating the distance of said patient from other subjects in a patient database using the multiple instances of network information flow; and

assigning said patient to a clinically relevant group based on the outcome of the previous step.

In a first step of the method datasets comprising one or more sets of molecular data from a patient sample may be obtained. A “patient” as used herein may be any higher eukaryotic organism comprising genetic information. Preferably, the patient is a human being, more preferably the patient is human being afflicted by a disease or suspected to be afflicted by a disease. Alternatively, the patient may also be an animal, e.g. a companion animal such as a dog, a cat, a cow, a horse, a pig etc. The methods of the present invention are, however, not limited to these groups of organisms, but can generally be used with any subject or organism comprising genetic, in particular genomic information.

A “patient sample” as used herein may be any sample derived from any suitable part or portion of a subject's body or organism. The sample may, in one embodiment, be derived from pure tissues or organs or cell types, or derived from very specific locations, e.g. comprising only one type of tissue, cell, or organ. In further embodiments, the sample may be derived from mixtures of tissues, organs, cells, or from fragments thereof. Samples may preferably be obtained from organs or tissues such as the gastrointestinal tract, the vagina, the stomach, the heart, the tongue, the pancreas, the liver, the lungs, the kidneys, the skin, the spleen, the ovary, a muscle, a joint, the brain, the prostate, the lymphatic system or organ or tissue known to the person skilled in the art. In further embodiments of the invention the sample may be derived from body fluids, e.g. from blood, serum, saliva, urine, stool, ejaculate, lymphatic fluid etc.

Particularly preferred is the employment of tumor tissue or the use of a sample derived from an organ known to be tumorous or cancerous. Also envisaged is the use of samples derived from any other organ or tissue or cell or cell type associated with or diagnosed to be affected by a disease, infection, disorder etc. In a specific embodiment of the present invention the sample may contain cells obtained from a solid tumor, from a tissue resection suspected to be tumorous or cancerous, from a biopsy of a diseased organ or tissue, e.g. an infected or cancerous organ or tissue, etc. The infection may, for example, be a bacterial or viral infection.

The sample may contain one or more than one cell, e.g. a group of histologically or morphologically identical or similar cells, or a mixture of histologically or morphologically different cells. Preferred is the use of histologically identical or similar cells, e.g. stemming from one confined region of the body.

In a specific embodiment a sample may be obtained from the same subject at different points in time, obtained from different organs or tissues of the same subject, or form different organs or tissues of the same subject at different points in time. For example, a sample of a tumor tissue and of one or more samples of a neighbouring, non-cancerous region of the same tissue or organ may be taken and used for obtaining datasets comprising one or more sets of molecular data.

The “molecular data” as used herein refers to data on a genetic, medical, biochemical, chemical, biological or physical condition or modality linked to a subject, e.g. a patient to be tested or a patient whose sample is analysed or is to be analysed. Non-limiting examples of such conditions or modalities comprise the molecular state of a gene or genomic locus, the presence or absence or amount/level of transcripts, proteins, truncated transcripts, truncated proteins, non-coding RNA transcripts, the presence or absence or amount/level of cellular or tissue markers, the presence or absence or amount/level of surface markers, the presence or absence or amount/level of glycosylation pattern, the form of said pattern, the presence or absence or amount/level of methylation pattern, the form of said pattern, the presence or absence of expression pattern on mRNA or protein level, the form of said pattern, cell sizes, cell behavior, growth and environmental stimuli responses, motility, the presence or absence or amount/level of histological parameters, staining behavior, the presence or absence or amount/level of biochemical or chemical markers, e.g. peptides, secondary metabolites, small molecules, RNAs, the presence or absence or amount/level of transcription factors, the form and/or activity of chromosomal regions or loci, as well as further conditions or modalities known to the person skilled in the art.

The term “datasets comprising one or more sets of molecular data” refers to datasets comprising data on the above mentioned conditions, e.g. comprising data on profiles of one or more of the molecular, genetic, medical, biochemical, chemical, biological or physical conditions associated with a patient or derived from a patient sample. Such datasets may comprise data on one condition or modality, or more than one condition, e.g. on a plurality of conditions, e.g. 2, 3, 4, 5, 6, 7, 8, 9, 10, 20, 50, 100 or more conditions or modalities. The datasets may comprise redundant or non-redundant information. The datasets may be provided in any suitable form known to the person skilled in the art, e.g. in suitable input formats for bioinformatic applications such as the raw data format, the FASTA format, plain text format, in the form of unicode text, in xml format, in html format, in Variant Call Format (VCF), in General Feature Format (GFF), in BED format, in AVLIST or in Annovar format.

In a further step of the method of the present invention the probability of an alteration within the one or more sets of molecular data is identified. Typically, this identification step is based on a comparison to a database of molecular data of known phenotypes. The term “alteration” as used herein refers to any change, variation, aberration, deviance or perturbation of comparable molecular data, e.g. molecular data as defined herein above or below, linked to a known molecular situation or phenotype. For example, if the molecular data relates to the expression of a gene, an alteration according to the present invention may be an overexpression of said gene, or an underexpression or repression of said gene. As additional information a lack of alteration, e.g. in the context of gene expression an expression at baseline level, may be registered. The alteration types or categories may be made dependent on the type of molecular data analysed and may accordingly be based on, for example, surpassing suitable thresholds, e.g. if the amount of a biological entity such as a protein or RNA etc. is analysed. Such threshold would be known to the person skilled in the art and/or can be derived from a description of phenotypes or be derived from suitable databases. The “probability” of said alteration may be determined according to any suitable algorithm or procedure known to the person skilled in the art. For example, the probability of said alteration may be calculated on the basis of a matrix of integrated molecular data values for a known phenotype. The methods to determine the probability of alteration of specific molecular entities may be different for different molecular data such as expression data, methylation data. The determination may be carried out by using algorithms that are well known for these molecular modalities. Subsequently, such a matrix may be used for the identification of associations with relevant, preferably clinically relevant outcomes. The term “known phenotypes” as used herein refers to any information on molecular or clinical situations providing a visible or otherwise detectable, e.g. clinically detectable, aspect previously recorded in the art, or otherwise known to the skilled person. Such aspects may be macroscopic, microscopic, histological or biochemical observations, or may be based on sequence information, gene expression information. Preferably, said known phenotypes are based on the integration of information on molecular or clinical situations, or the accumulation of such information in molecular terms, e.g. reflecting all, essentially all or the most relevant factors contributing to a macroscopic, microscopic, histological or biochemical observation etc. In a preferred embodiment these phenotypes and in particular any contributing factors may be provided or presented in the form of a database.

In a further step of the method of the present invention the activity of a biological network may be inferred on the basis of the probability of an alteration within the one or more sets of molecular data as defined above. The term “biological network” as used herein refers to a group of biological or molecular interactions, preferably linked by the macroscopic, microscopic, histological or biochemical observation. Non-limiting, envisaged examples of such biological networks are a predefined biologically meaningful subset of genes, a network of interaction genes or genetic factors, a biological pathway, a predefined biological process, or a predefined molecular interaction or function. A “biological pathway” as used herein refers to a set of interactions occurring between a group of genes or factors, which genes or factors depend on each other's individual functions in order to make the aggregate function of the interactions available to the cell. A “predefined biologically meaningful subset of genes” as used herein may, for example, comprise a set of genomic regions with a functional impact, a regulome in dependence on specific factors, e.g. growth factors, nutrients, transcription factors, cell size, stress etc. A “predefined biological process” as used herein may include, for example, transcription regulation, metabolic processes, cellular responses to outside factors, cellular responses to stress, growth factors, nutrient supply etc., or intracellular transport activity. A “predefined molecular interaction or function” may, for example, comprise ligand-receptor interactions, ligand-ion channel interactions, rector binding, e.g. the binding of androgen to its cognate receptor etc. The term “inferred” as used herein relates to a suitable derivation or calculation activity resulting in the identification of biological networks. For example, suitable algorithms such as the junction tree inference algorithm, preferably with HUGIN updates, the Belief Propagation with sequential updates, or the expectation-maximization (EM) algorithm may be used. These and further suitable algorithms would be known to the person skilled in the art, or could be derived from suitable scientific documents, such as Vaske et al., 2010, Bioinformatics, 26(12): i237-i245, which is incorporated herein by reference in its entirety.

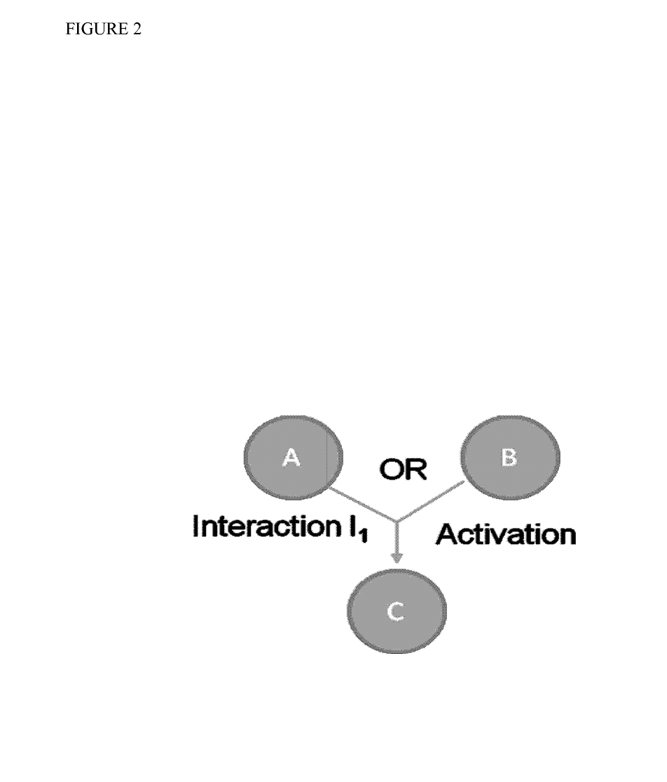

In another step of the method of the present invention a network information flow probability for the examined patient or the patient's examined tissue or cell sample is identified. This identification process is based on the probabilities of the altered molecular data as described herein. The term “network information flow” or “network information flow probability” as used herein refers to the information provided by interactions amongst genes or other factors captured in the identified network, preferably in a captured biological pathway. For example, if a network defines an interaction between Gene A, Gene B and Gene C (e.g. as shown in FIG. 2), this interaction in the network may indicate that either Gene A or Gene B need to be altered, e.g. be over-expressed, in order for Gene C to be altered, e.g. be over-expressed. The network information flow may accordingly be seen as the probability of an interaction (I₁), reflected by the joint probability of Gene B or Gene A being altered, and Gene C being altered at the same time, e.g. be over-expressed. This joint probability (p₁) is the probability that the particular interaction (between Gene A, Gene B and Gene C) was activated in this patient. The network information flow or the network information flow probability thus provides a functional unit for the probability that a particular interaction is activated. The network information flow may be identified for one interaction, or more than one interaction, e.g. in dependence on the biological network identified. The number of interactions, as well as dependencies of interactions, interrelationships etc. may accordingly depend on the biological network identified in the previous method step. A vector of such probabilities for all the interactions defined in a specific biological network, or pathway, would be considered as “network information flow vector” within the context of the present invention.

In a special embodiment of the present invention network information flows or networks information flow probabilities may further be combined, integrated, merged or consolidated according to any suitable scheme, e.g. in reflection of the underlying biological network. Furthermore, specific interactions may be excluded or disregarded, e.g. in dependency of threshold values, such as amount thresholds, expression threshold, size thresholds etc. Suitable threshold values would be known to the person skilled in the art, or could be derived from qualified textbooks or scientific literature.

In a further step of the present method, multiple instances of a network information flow for a patient sample may be created. A network information flow vector as defined herein above may hence be seen as a vector of probabilities, where each probability is the likelihood that a particular interaction in the biological network was activated in the patient. Such an information flow vector may, for example, have the form

V=[I₁I₂I₃ . . . I_{N}]

where each position corresponds to a specific interaction in the biological network. From this vector of probabilities, multiple network information flow state vectors may be created, wherein every interaction in a given biological network and a given patient or subject is assigned a particular state of active (e.g. represented as a 1 in that position) or inactive (e.g. represented as a 0 in that position). The probability of a 1 or a 0 in any given position in an instance of the network information flow vector may accordingly be considered equal to the probability of that interaction being active, as calculated in the previous step. If, for example, the probabilities of activation of all of the interactions in a specific biological network, e.g. in a biological pathway, are given as {p₁, p₂, p₃, . . . , p_{N}} multiple sample states from these network information flows may be generated. Each sample state may, for example, be represented as a vector of 0 s and 1 s of the same length as the network information flow probabilities, thus capturing one possible state of the biological network for the patient or subject, where some of the interactions are active and others are inactive.

In a specific embodiment sample states or sample state vectors may be generated from the probabilities in the network information flow vector with the Metropolis-Hastings sampling algorithm, Gibbs sampling, slice sampling, or any Monte Carlo sampling methods.

For example, the distribution of sample and network information flow vectors may have the form:

v1=[1 1 0 . . . 1]

v2=[1 0 0 . . . 1]

v3=[0 1 0 . . . 0]

v4=[1 1 1 . . . 0]

Typically, said distribution of sample or network information flow vectors represents the information flow in a network for the tested patient, i.e. provides aggregated or cumulative information on network, e.g. pathway, activation or its relevance with regard to superior or high-ranking networks or cellular activities.

These multiple samples may preferably be used as means to capture the full probability distribution of interaction states in a specific network, e.g. within a specific pathway for a given patient. In a preferred embodiment, the distribution of information flow states for the N interactions of a network based on their individual probabilities may be generated for a patient or subject examined. The term “full probability distribution of interaction states in a specific network” as used herein means the joint probability of each interaction in the network being active.

In a further embodiment, the interactions may be ordered in any suitable manner. In a typical embodiment the interactions may be ordered according to their relative positions within the network, e.g. within a pathway. The position within a network or pathway may be derived from suitable information repositories, e.g. from pathway databases, interaction databases etc., or form suitable scientific literature. The network information flow vector for a given biological network may preferably be ordered pursuant to the structure of the biological network. For example, if a biological network is, for example, considered to be a directed acyclic graph (DAG), the interactions that appear closer to the root of the biological network may be weighted differently compared to those interactions that occur at the leaves of the biological network. This preferential ordering of the interactions may lead to a preferential ordering of the network information flow vector capturing the whole biological network. Subsequently, the preferential ordering of the network information flow vector may be captured in the form of weights, whose values can assign higher importance to some interactions over others in the network. However, the presently described methodology is not limited to this approach. The present invention accordingly envisages the use of several other possible network properties, e.g. properties which can be used to order the states in the network such as betweenness, centrality, clustering coefficient, degree, etc. These properties represent metrics derived from social network analysis known to the person skilled in the art. Further details may be derived from qualified literature on social network analysis.

In a particularly preferred embodiment, the network may be provided or defined in the form of a directed acyclic graph (DAG). The interactions may accordingly be ordered based on their depth from a top node of the graph. Alternatively, the network may be provided in a cyclic graph. The network may accordingly be broken down and the cycles may be resolved, yielding and representing a directed acyclic graph (DAG).

In a further particularly preferred embodiment, the probability of activation of one, more or each of these interactions or the creation of multiple instances of network information flow may be used to create a distribution of sample and network information flow vectors.

However, the present invention is not limited to this form. Further, alternative forms or orders of interactions are also envisaged. The present invention accordingly also envisages network modules comprising small networks or sub-networks, and therefore information flow between network modules may be represented as information flow vectors. In a specific embodiment, one or more higher level modules, networks or supra-networks may comprise more than one small network, single module or sub-network. Accordingly, an information flow may be derived from an interaction of said network hierarchy, e.g. any interaction between lower and higher ranking modules within a supra-network or group of hierarchically ordered small networks or single network modules, or between different modules on the same level of hierarchy. Method steps defining such an information flow among network modules instead of genes or molecular alterations may preferably be implemented on the basis of the herein described principle.

In a further embodiment the distribution of network information flow vectors may also be monitored on the basis of activity or alteration levels of genes, genomic loci, transcripts etc., or groups or combinations thereof which are involved or underlying said network information flow vectors, or which are involved or underlying the interactions contributing to said network information flow vectors.

In a particularly preferred embodiment of the present invention any inconsistent states which may be encountered in a monitoring on the basis of activity or alteration levels of genes, genomic loci, transcripts etc., or groups or combinations thereof which are involved or underlying said network information flow vectors, or which are involved or underlying the interactions contributing to said network information flow vectors, may be rejected from an overall distribution.

In a further step of the present invention the distance of the patient, whose sample is tested according to the above defined steps, from other subjects in a patient database is calculated. This calculation may be based on the multiple instances of the network information flow. The term “distance” as used herein refers to a mathematical or statistical distance between two or more instances of the network information flow as define herein above. The distance may be calculated with any suitable method, process or algorithm known to the person skilled in the art. The term “other subjects in a patient database” as used herein refers to one or more subjects, in particular to one or more subject data, which are derivable from a data repository. Such a subject may be healthy or normal with regard to a specific disease or medical condition. Alternatively, the subject may be afflicted by a disease or medical condition, preferably they may be afflicted by a disease or medical condition which has been diagnosed, detected and/or established independently. An independent diagnosis or detection may be based on all suitable diagnostic procedures, e.g. histological, biochemical, genetic etc. The term “healthy subject” as used herein relates to an organism, preferably a human being not afflicted by a specific disease in comparison to a second subject, e.g. human being, with regard to the same disease. The term “healthy” thus refers to specific disease situations for which a subject shows no symptoms of disease. The term thus not necessarily means that the person is entirely free of any disease. However, also these persons are envisaged as being healthy for the purpose of the present invention.

Furthermore, the subject in said patient database may have been identified as having a predisposition for a certain disease or medical condition. Such predispositions may include the presence of nucleotide polymorphisms, gene duplications, genome rearrangements, specific gene expression values etc. as would be known to the person skilled in the art. Preferably, molecular data or datasets comprising one or more sets of molecular data from a patient database may be used for the creation of network information flows according to the herein described method. More preferably, network information flows or network information flow vectors obtained by a corresponding performance of the above or below described method steps of the present invention on the basis of molecular data or datasets comprising one or more sets of molecular data from a patient database may be used for a calculation of the distance of corresponding network information flows, more preferably of corresponding network information flow vectors.

In a specific embodiment said calculation of the distance may be carried out on the basis of more than one subject in a patient database, e.g. on the basis of data from 2, 3, 4, 5, 10, 20 or more subjects. These subjects may preferably have been identified as being afflicted by the same or a similar disease or medical condition. They may be afflicted by a disease or medical condition, which has been diagnosed, detected and/or established independently. Data from these subjects may be averaged before calculating the distance of the patient whose sample is tested according to the above defined steps.

In yet another embodiment, said calculation of the distance may be carried out on the basis of already provided or given network information flows from other subjects. Such network information flows may be present in a specific database or data repository, or have been obtained in previous or independent runs of the presently claimed method. Alternatively, the network information flows may have been obtained from the examined or tested patient in earlier examinations or earlier runs of the presently claimed method.

In a particularly preferred embodiment of the present invention said distance of a patient from other subjects may be calculated as the average of pairwise distance of information flow vectors in the context of a given network. For example, the average of pairwise distance of information flow vectors of a patient and 1, 2, 3, 4, 5, 10, 15, 20, 50, 100 or more subjects or any other number of subjects as derivable from a patient database may be calculated. For the calculation of the average of pairwise distance of information flow vectors any suitable procedure, algorithm or distance measurement may be used. For example, the distance may be calculated according to suitable procedures known from the information retrieval theory such as a procedure computing the Manhattan distance, the Mahalanobis distance, or the Chi-square distance. Also envisaged are the computation of a 1-correlation of two vectors. Details and further parameters of these procedures would be known to the skilled person or could be derived from suitable textbooks or qualified literature.

In a further preferred embodiment said pairwise distance of information flow vectors may be calculated as the Euclidean distance between the information flow vectors in a given network, e.g. the Euclidean distance of between the information flow vectors of a patient and 1, 2, 3, 4, 5, 10, 15, 20, 50, 100 or more subjects or any other number of subjects as derivable from a patient database. For example, in the case of two patients (patient 1 being the examined patient, patient 2 being a subject whose data are derivable or derived from a patient database), the following formula, wherein x is a sample information flow vector for the given network, e.g. pathway, belonging to patient 1 and y is a sample information flow vector belonging to patient 2, may be used for the calculation of the Euclidean distance between the information flow vectors in said network:

$$D ( Patient 1 , Patient 2 ) = {\sum }_{x} {\sum }_{y} ( x - y ) \cdot ( x - y )$$

In yet another preferred embodiment said pairwise distance of information flow vectors may be calculated as a weighted Euclidean distance. In a particularly preferred embodiment of the present invention said calculation of weighted Euclidian distance may be based on weights for each entry in the information flow vector being proportional to the depth of that interaction in a given network.

In a final step of the present method the examined or tested patient is assigned to a clinically relevant group. This assignment is based on the results and outcome of the calculation of distance of said patient form other subjects in the patient database as defined herein above or below. The term “assigning” as used herein refers to the determination of a probability that a patient is similar or identical with a subject in a patient database regarding molecular data, phenotypes, symptoms etc. The term thus includes a diagnosis or detection of a disease or medical condition, or the detection of a predisposition of a disease or medical condition based on the results and outcome of the calculation of distance of a patient form other subjects in a patient database as defined herein above or below. The term “clinically relevant group” as used herein refers to a group of subjects or patients afflicted by a clinically detectable or clinically important condition, e.g. a disease, a predisposition for a disease etc. Such groups may be identified by identical or similar symptoms, phenotypes, molecular behavior etc. This term includes any disease or medical condition, which is differentiable on the basis of molecular data derivable form a patient sample. Specific data and information with regard to clinically relevant groups would be known to the person skilled in the art, or could be derived from qualified literature, e.g. medical textbooks, data repositories etc.

In a further particularly preferred embodiment of the present invention said assignment of said patient to a clinically relevant group may be performed with a clustering algorithm. For example, said assignment may be performed with a clustering algorithm based on the pairwise distances of said patient with one, more or all subjects in a patient database. Suitable clustering algorithms would be known to the person skilled in the art. Based on the employment of such an algorithm subgroups of patients may be defined. Alternatively or additionally, other unsupervised learning methods may be employed.

In a preferred embodiment, the number of clusters obtained with the help of any of the above described methods or algorithms is similar to, or essentially correspond or is identical to the number of phenotypes, e.g. clinical phenotypes, the method according to the present invention is able to distinguish.

In specific embodiments of the present invention said groups of patients can be characterized based on survival curves, e.g. if the outcome is disease or cancer survival. Survival curves may be plotted using suitable estimators, preferably the Kaplan-Meier estimator. In a further specific embodiment the Kaplan-Meier estimator may be used to estimate the probability of cancer progression, more preferably of ovarian cancer progression, or of cancer recurrence, more preferably of ovarian cancer recurrence after a platinum therapy. The statistical significance of survival differences between the groups of patients may be evaluated using suitable procedures, e.g. the log-rank or the Mantel-Haenszel test of the difference in Kaplan-Meier curves.

In a preferred embodiment of the present invention said patient database as mentioned herein above or below may be a disease related database. The term “disease related database” means a database comprising data on patients or subjects afflicted by a specific disease or medical condition, or a group or family of diseases or medical conditions. Such a database may comprise any suitable amount or type of information, e.g. any type of molecular data on a subject suffering from a specific disease, in particular altered values with respect to comparable or healthy, normal subjects. The database may also comprise averaged values derived from more than one subject suffering from the same or a similar disease or medical condition. In a particularly preferred embodiment said disease related database may be a cancer disease related database. In a specific embodiment The Cancer Genome Atlas (TCGA) database may be used. However, further suitable cancer specific databases may alternatively or additionally be used.

The database may be a database of any provenience, size, structure or identity. For example, such a database may be a database located at and/or maintained by a hospital or a medical practice or any other healthcare facility. It may, for instance, comprise specific data of the patients attended in said facility, or which have been attended there in the past. Such databases may also comprise interfaces with more extensive, e.g. regional, statewide or nationwide or international databases etc.

In a specific embodiment of the present invention the steps of the method as defined herein above or below may be performed once or more times on the basis of the same biological network, e.g. biological pathway, or on the basis of a different biological network, e.g. biological pathway. For example, the steps may be performed for any biological network, e.g. biological pathway, indicated in a corresponding database, e.g. in a pathway database. Alternatively, the steps may be performed for a subset of biological networks, e.g. pathways indicated in a suitable database, e.g. in a pathway database. These performances of the method may also be repeated once or more times, e.g. on the basis of different databases, on the basis of an additional set of molecular data, on the basis of an intervening statistical assessment of data or interactions etc.

In a preferred embodiment of the present invention, the molecular data from a patient sample may comprise data on nonsense mutations, single nucleotide polymorphisms (SNP), copy number variations (CNV), splicing variations, variations of a regulatory sequence, small deletions, small insertions, small indels, gross deletions, gross insertions, complex genetic rearrangements, inter chromosomal rearrangements, intra chromosomal rearrangements, loss of heterozygosity, insertion of repeats, deletion of repeats, DNA methylation, histone methylation or acetylation states, gene and/or non-coding RNA expression and/or chromatin precipitation data revealing DNA binding sites or regions and/or any combination of these signatures. Further suitable variations and modifications of the genome, transcriptome or regulome, or of a subject's genetic sequence or expression state etc. would be known to the person skilled in the art. Molecular data regarding such additional variations or potential variations are also encompassed within the present invention.

In a further preferred embodiment said molecular data may be obtained by any suitable technique, method or approach known to the person skilled in the art. For example, the data may be obtained by sequencing, in particular genome sequencing or the sequencing of portions of the genome, e.g. of specific regions or genes, or of expressed sequences, e.g. cDNA sequencing etc. Methods for sequence determination are known to the person skilled in the art. Preferred are next generation sequencing methods or high throughput sequencing methods. For example, a subject's genomic sequence may be obtained by using Massively Parallel Signature Sequencing (MPSS). An example of an envisaged sequence method is pyrosequencing, in particular 454 pyrosequencing, e.g. based on the Roche 454 Genome Sequencer. This method amplifies DNA inside water droplets in an oil solution with each droplet containing a single DNA template attached to a single primer-coated bead that then forms a clonal colony. Pyrosequencing uses luciferase to generate light for detection of the individual nucleotides added to the nascent DNA, and the combined data are used to generate sequence read-outs. Yet another envisaged example is Illumina or Solexa sequencing, e.g. by using the Illumina Genome Analyzer technology, which is based on reversible dye-terminators. DNA molecules are typically attached to primers on a slide and amplified so that local clonal colonies are formed. Subsequently one type of nucleotide at a time may be added, and non-incorporated nucleotides are washed away. Subsequently, images of the fluorescently labeled nucleotides may be taken and the dye is chemically removed from the DNA, allowing a next cycle. Yet another possible and envisaged method of obtaining a subject's genomic sequence is the use of Applied Biosystems' SOLiD technology, which employs sequencing by ligation. This method is based on the use of a pool of all possible oligonucleotides of a fixed length, which are labeled according to the sequenced position. Such oligonucleotides are annealed and ligated. Subsequently, the preferential ligation by DNA ligase for matching sequences typically results in a signal informative of the nucleotide at that position. Since the DNA is typically amplified by emulsion PCR, the resulting bead, each containing only copies of the same DNA molecule, can be deposited on a glass slide resulting in sequences of quantities and lengths comparable to Illumina sequencing. A further envisaged method is based on Helicos' Heliscope technology, wherein fragments are captured by polyT oligomers tethered to an array. At each sequencing cycle, polymerase and single fluorescently labeled nucleotides are added and the array is imaged. The fluorescent tag is subsequently removed and the cycle is repeated. Further examples of sequencing techniques encompassed within the methods of the present invention are sequencing by hybridization, sequencing by use of nanopores, microscopy-based sequencing techniques, microfluidic Sanger sequencing, or microchip-based sequencing methods. The present invention also envisages further developments of these techniques, e.g. further improvements of the accuracy of the sequence determination, or the time needed for the determination of the genomic sequence of an organism etc. The genomic sequence may be obtained in any suitable quality, accuracy and/or coverage. The acquisition of the genomic sequence also includes in specific embodiments the employment of previously or independently obtained sequence information, e.g. from databases, data repositories, sequencing projects etc.

Alternatively, molecular data may be obtained with immunohistochemical (IHC) methods or approaches. Accordingly, by detecting antigens in cells of a tissue section via suitable antibodies or interactors the presence of abnormal or altered cells or tissue regions and/or the distribution and localization of biomarkers and differentially expressed proteins in different parts of a biological tissue may be detected. Visualising an antibody-antigen interaction can be accomplished in several ways. For example, an antibody may be conjugated to an enzyme, e.g. peroxidase, that can catalyse a colour-producing reaction. Alternatively, an antibody may be tagged to a fluorophore, e.g. fluorescein or rhodamine etc.

In a specific embodiment, molecular data may be obtained with methods of fluorescence in situ hybridization (FISH). Accordingly, the presence or absence of specific DNA sequences on chromosomes may be detected with the help of fluorescent probes that may bind to specific parts of the chromosome with which they show a high degree of sequence similarity.

Alternatively, PCR-techniques may be used. Corresponding methods and procedures would be known to person skilled in the art. Typically, quantitative PCR or real-time PCR methods may be performed. Furthermore, multiplex PCR methods may be performed. Further details and method parameters may be derived from suitable textbooks or protocol collections.

The present invention further envisages the acquisition of molecular data with the help of microarrays. Microarrays may be DNA microarrays such as cDNA microarrays, oligonucleotide microarrays or SNP microarrays, or MMChips for the detection of microRNAs or microRNA populations. Alternatively, the microarrays may be protein microarrays, tissue microarrays allowing multiplex histological analyses, cellular microarrays allowing the multiplex testing of living cells, antibody microarrays, or glycoarrays. Further details, product and method parameters would be known to the skilled person, or may be derived from suitable textbooks or protocol collections.

Molecular data obtained with the help of any of the mentioned methods may be organized, structured, revised and controlled according to suitable statistical or molecular procedures or controls. For example, the relevance of the data may be tested and controlled on the basis of suitable statistical methods; the quality of sequence data may be tested with the help of suitable controls etc.

Molecular data may alternatively or additionally be derived from databases or data repositories, or may be derived from previous runs of the presently described method with the same patient and/or relative or family member, or a member of group or association the patient belongs to.

In a further preferred embodiment of the present invention the identification of the probability of an alteration within the one or more sets of molecular data as defined herein above may be carried out by a comparison to a biological annotation database, a pathway database, a database on biological processes and/or a database on biological functions. Preferably, molecular data on the expression of one or more of a patient's genes or of RNA species comprising transcripts or non-translated RNAs may be compared with a biological annotation database, a pathway database, a database on biological processes and/or a database on biological or molecular functions.

In a particularly preferred embodiment said biological annotation databases, pathway databases, databases on biological processes and/or databases on biological functions may comprise data on normal, healthy, non-aberrant situations, conditions, tissues, sequences, phenotypes, genotypes, the non-occurrence of symptoms etc. Accordingly, comparisons may be carried out on the basis of a matching of molecular data or sets of molecular data derived from a patient with molecular data or sets of molecular data associated with normal, healthy, non-aberrant situations, conditions, tissues, sequences, phenotypes, genotypes, the non-occurrence of symptoms etc.

Alternatively or additionally, said comparison may include a matching with molecular data associated with diseases, medical conditions, aberrant genomic structures, aberrant expression etc.

Preferred databases are the National Cancer Institute Pathway interaction database, the KEGG pathway database, the BioCarta database, the Panther database, the Reactome database, and the DAVID database. The presently claimed method is, however, not limited to the mentioned databases, but may be carried out also with the help of any other suitable molecular databases. Particularly preferred is a pathway database, e.g. one of the pathway databases as mentioned above.

In a particularly preferred embodiment of the present invention the probability of an alteration within the one or more sets of molecular data may be identified by estimating altered expression levels of individual genes in the network by integrating said molecular data. The term “altered expression level of individual genes” as used herein refers to the expression of RNA species or protein/polypeptide/peptide species from specific genes, for which a typical, normal, healthy and/or non-aberrant expression is known and preferably registered or present in a corresponding database or data repository, wherein said typical, normal, healthy and/or non-aberrant expression level is not given or changes (e.g. is up-regulated, down-regulated, over-expressed, repressed etc.) in the examined individual gene or genes. In the context of the embodiment the term “integrating molecular data” refers to a comparison and assessment process for these expression data on the basis of a biological annotation base, pathway database, database on biological processes and/or database on biological functions, or any other suitable database. In a specific embodiment, such a database comprises expression level information on said individual genes derived from normal, healthy subjects. Also envisaged is an integration of more than one gene, e.g. of averaged expression values of a group of genes, a pathway, a regulome etc.

In another preferred embodiment said probability of an alteration within the one or more sets of molecular data is identified by estimating altered copy number levels, altered methylation states, or altered gene function due to mutations of genomic loci or genomic regions in the network by integrating said molecular data. The terms “altered copy number levels”, “altered methylation states” and “altered gene function due to mutations of genomic loci or genomic regions” as used herein refer to copy number levels, methylation states or gene functions at genomic loci or in genomic regions, respectively, for which a typical, normal, healthy and/or non-aberrant copy number level, methylation state or gene function at said genomic locus or in said genomic regions is known and preferably registered or present in a corresponding database or data repository, wherein said typical, normal, healthy and/or non-aberrant copy number level, methylation state or gene function at said genomic locus or in said genomic regions is not given or changed (e.g. mutated, modified, present in a different number or amount etc.) in the examined genomic locus or in said genomic regions. The term “methylation state” as used herein refers to the state of DNA methylation, histone methylation or both. In the context of the embodiment the term “integrating molecular data” refers to a comparison and assessment process for these copy number level, methylation state and gene function data on the basis of a biological annotation base, pathway database, database on biological processes and/or database on biological functions, database on mutations, methylation states, copy number, genomic structure etc. or any other suitable database. In a specific embodiment, such a database comprises information on the copy number level, methylation state or gene function at a genomic locus or in a genomic regions derived from normal, healthy subjects. Also envisaged is an integration of more than locus or region, or different genomes, or different genomic contexts, e.g. population contexts etc.

In further embodiments of the invention the probability of an alteration within the one or more sets of molecular data may be identified by estimating different or additional factors, e.g. splicing variations, variations of a regulatory sequence, alteration with respect to small deletions, small insertions, small indels, gross deletions, gross insertions, complex genetic rearrangements, inter chromosomal rearrangements, or intra chromosomal rearrangements, e.g. the presence or absence of such modifications, or variations with regard to the loss of heterozygosity, the insertion or presence of repeats, the deletion or absence of repeats, variations with regards to histone acetylation states, non-coding RNA expression or variations concerning chromatin precipitation data revealing DNA binding sites or regions. Further suitable molecular alterations or modification known to the person skilled in the art may also be identified. Said alterations of molecular data may accordingly be integrated as defined herein above or below.

In a specific embodiment said probability of an alteration may be estimated by using a probabilistic graphical model framework, i.e. the probability of an alteration within the one or more sets of molecular data may be identified by estimating altered molecular values as defined herein above (gene expression, copy number etc.) by integrating said molecular data using a probabilistic graphical model framework. The term “probabilistic graphical model” as used herein refers to an approach to characterize joint probability distributions where nodes in the graph are random variables and edges in the graph represent probabilistic relationships between these variables. The graph may accordingly represent the way in which the joint probability of all the variables can be decomposed into a product of factors, each depending on only a subset of all the variables.

Suitable examples of probabilistic graphical model frameworks, which are encompassed by the present invention, include Bayesian networks and Markov random fields.

A particularly preferred approach for inference in a probabilistic graphical model as described herein is a factor graphs framework. Alternatively or additionally, other inference methods such as the sum-product algorithm, the max-sum algorithm, the loopy belief propagation etc. may be used.

In a specific embodiment of the present invention said probability of an alteration may be estimated by using the pathway recognition algorithm using data integration on genomic models (paradigm)-approach as described in Vaske et al., 2010, Bioinformatics, 26(12): i237-i245.

In a further embodiment of the present invention the interactions which contribute to the identification of a network information flow probability may be interactions for genes or genomic loci with molecular alterations. The term “interactions for genes with molecular alterations” as used herein refers to any type of interaction (I₁), which connects the function, expression, expression product, transcript, translation product, or regulation of gene to the function, expression, expression product, transcript, translation product, or regulation of one or more other genes, wherein at least for one of these genes an alteration of the mentioned parameters, or of other parameters as defined herein above has been identified. Such a connection may a direct or indirect connection, e.g. based on direct interactions, or indirect interactions conveyed by additional factors or parameters. The term “interactions for genomic loci with molecular alterations” as used herein refers to any type of interaction (I₁), which connects the function, state, e.g. methylation state, activity state, structure, presence, absence, presence of one or more genomic loci, wherein at least for one of these genomic loci an alteration of the mentioned parameters, or of other parameters as defined herein above has been identified. Such a connection may be a direct or, preferably, an indirect connection, e.g. mediated by binding factors, transcription factors, the presence of DNA or histone methylation or demethylation enzymes etc.

Alternatively, the interaction may also connect the function, expression, expression product, transcript, translation product, or regulation of gene to the function, expression, expression product, transcript, translation product, or regulation of gene with the function, state, e.g. methylation state, activity state, structure, presence, absence of one or more genomic loci. Typically, these interactions or interaction types represent causality in terms of biological or molecular function of a gene or locus to be examined, e.g. a target gene or target locus, such as genes or loci showing alterations as defined herein.

In a further preferred embodiment of the present invention the interactions as defined above may be interactions for genes or genomic loci with molecular alterations, wherein said genes or genomic loci belong to a biological network. In a particularly preferred embodiment, said interactions may be related to genes belonging to a biological network as defined in a pathway database, e.g. in the National Cancer Institute Pathway interaction database, the KEGG pathway database or the BioCarta database. In a further preferred embodiment, said interactions may be related to genomic loci or genomic regions with functional impacts, e.g. being connected via a regulome, a common transcription regulation, common metabolic processes, common cellular responses to outside or inside factors, e.g. stress, nutrients, growth factors etc., common intercellular transport activity. Such connections or implications may be derived from suitable databases, e.g. the National Cancer Institute Pathway interaction database.

In preferred embodiment of the present invention a clinically relevant group as mentioned herein above, i.e. a clinically relevant group to which a patient is assigned to according to the method of the present invention, may be associated with a cancerous disease. The term “cancerous disease” refers to any cancer or tumor, in particular malignant tumor form known to the person skilled in the art. In a particularly preferred embodiment said cancerous disease may be ovarian cancer, breast cancer, or prostate cancer. Most preferred is ovarian cancer.

In a further embodiment of the present invention said clinically relevant group may be associated with the likelihood of recurrence of a cancerous disease in a subject after a therapy. The term “likelihood of recurrence” as used herein refers to the probability that a subject may develop a cancerous disease, e.g. the same cancerous disease, after a therapy has been finished. Also included is the likelihood that a subject may show a more advanced stage of a cancerous disease or show a deterioration of the cancerous disease after a therapeutic approach has retained the cancerous disease. The term “therapy” or “therapeutic approach” as used herein refers to the use of pharmaceutical or chemical substances to treat a cancerous disease. In a preferred embodiment said likelihood of recurrence is a likelihood to develop ovarian cancer, breast cancer, or prostate cancer after a corresponding therapy.

In yet another preferred embodiment of the present invention said clinically relevant group may be associated with the likelihood of responsiveness of a subject to a therapy. Such a therapy may be of any type, for instance a chemotherapy, e.g. a chemotherapy against a disease. The term “likelihood of responsiveness” as used herein refers to the probability that a subject may develop a non-responsive state towards the therapy, e.g. develops a resistance against the therapy or the given therapeutic composition. The term “chemotherapy” as used herein means the use of pharmaceutical or chemical substances to a disease, in particular to treat cancer.

In a specific embodiment of the present invention said clinically relevant group may comprise ovarian cancer patients that respond to platinum therapy versus those who do not respond. In a further specific embodiment of the present invention said clinically relevant group may comprise breast cancer patients who have higher risk of relapse of breast cancer versus those with lower relapse risk. In yet another specific embodiment of the present invention said clinically relevant group may comprise breast cancer patients who achieve complete pathological response to neoadjuvant therapy versus those who do not.

In a particularly preferred embodiment said clinically relevant group may be associated with the likelihood of responsiveness of a subject to a therapy comprising one or more platinum based drugs. Examples of platinum based drugs are cisplatinum and derivatives or analogs thereof, e.g. oxiplatinum, satraplatinum.

In a particularly preferred embodiment said platinum based drug is carboplatinum. A methodology as described herein above may, hence, be used to identify patients with a high or low likelihood to respond to a platinum based therapy, in particular to a carboplatinum based therapy, e.g. during the treatment of a cancer disease, in particular during the treatment of ovarian cancer.

In another aspect the present invention relates to a biomedical marker or group of biomedical markers, wherein said biomedical marker or group of biomedical markers comprises at least 3, 4, 5, 6, 7, 8, 9, 10, 11, 12, 13 or all markers selected from an altered endothelin pathway, an altered ceramide signaling pathway, an altered rapid glucocorticoid signaling pathway, an altered paxilin independent a4b1 and a4b7 pathway, an altered osteopontin pathway, an altered IL6 signaling pathway, an altered telomerase pathway, an altered JNK signaling pathway in the CD4+TCR pathway, an altered PLK2- and PLK4-pathway, an altered EPO-signaling pathway, an altered p53-pathway, an altered VEGFR1- and VEGFR-2 signaling pathway, an altered VEGFR1-specific pathway, and an altered syndecan-1 signaling pathway, as indicated in the following Table 1:

TABLE 1

| | Pathway reference/ID number in NCI- |
|---|---|
| Pathway Name | PID |
| altered endothelins pathway | endothelinpathway, rev. 16-Sep-2010 |
| altered ceramide signaling pathway | ceramide_pathway, rev. 9-Aug-2010 |
| altered rapid glucocorticoid signaling pathway | rapid_gr_pathway, rev. 8-Jun-2009 |
| altered paxillin-independent events mediated by a4b1 | a4b1_paxindep_pathway, rev. 9-Feb-2009 |
| and a4b7 pathway | |
| altered osteopontin-mediated events pathway | avb3_opn_pathway, rev. 13-Jul-2009 |
| altered IL6 mediated signaling events pathway | il6_7pathway, rev. 10-Jan-2011 |
| altered regulation of Telomerase pathway | telomerasepathway, rev. 9-Mar-2009 |
| altered JNK signaling in the CD4+TCR pathway | tcrjnkpathway, rev. 9-Mar-2009 |
| altered PLK2 and PLK4 events pathway | plk2_4pathway, rev. 13-Apr-2009 |
| altered EPO signaling pathway | epopathway, rev. 8-Sep-2008 |
| altered p53 pathway | p53regulationpathway, rev. 7-Oct-2009 |
| altered signaling events mediated by VEGFR1 and | vegfr1_2_pathway, rev. 8-Aug-2007 |
| VEGFR2 pathway | |
| altered VEGFR1 specific signals pathway | vegfr1_pathway, rev. 12-Aug-2008 |
| altered Syndecan-1-mediated signaling events pathway | syndecan_1_pathway, rev. 13-Apr-2009 |

The mentioned pathways are in particular defined according to NCI-PID identifiers and date codes allowing the person skilled in the art to determine the pathway members, factors and interactions, for example all genes contribution to the pathway, by consulting the information repository at the pathway interaction database of the National Cancer Institute. The pathway information as provided in Table 1 is however to be seen as only one representation of pathway information or one possibility of providing pathway information according to the present invention. Alternatively, different pathway information sources or databases providing essentially the same information content may also be used for a representation of pathway information according to the present invention, e.g. information derived from the KEGG pathway database. Furthermore, changes to pathway definitions or changes to interactions between pathway members, or the presence or absence of pathway members is considered to be encompassed within the scope of the present invention as long as the principle pathway structure or setup as derivable from the information provided in Table 1 is not obviated.

In a particularly preferred embodiment of the present invention the mentioned biomedical marker or group of biomedical markers is associated with a high likelihood of responsiveness of a subject to a cancer therapy, more preferably to an ovarian cancer therapy.

In a further particularly preferred embodiment of the present invention the mentioned biomedical marker or group of biomedical markers is associated with a high likelihood of responsiveness of a subject to an ovarian cancer therapy comprising platinum based drugs. In yet another particularly preferred embodiment of the present invention the mentioned biomedical marker or group of biomedical markers is associated with a high likelihood of responsiveness of a subject to an ovarian cancer therapy comprising carboplatinum or cisplatinum.

The term “altered pathway” as used herein means that at least one gene participating in the pathway as defined herein above or indicated in Table 1 shows an altered expression, e.g. over-expression or repression, in comparison to a normal or healthy version of said gene or to a corresponding reference as described herein above. This alteration may be by a factor of 5%, 6%, 7%, 8%, 10%, 15%, 20%, 25%, 30%, 40%, 50% or more in comparison to said normal or healthy version of said gene, or an average of 2, 5, 10, 20, 100 or more samples of normal or healthy versions of said genes, preferably under comparable molecular conditions such as nutrition, cell size, age etc. In specific embodiments, the altered pathway may be altered not only in the expression of one gene, but in the expression of two or more genes, or sub-groups or branches of said pathway. Furthermore, the expression of all genes participating in said pathway may be altered. In further embodiments, said altered pathways may show alterations as identifiable according to the methods of the present invention, e.g. information flow vectors showing differences in the interaction pattern of the pathway on the basis of gene expression.

In further embodiments an altered pathway may additionally or alternatively comprise an alteration in the genomic sequence of the genes or genomic loci of genes participating in the pathway, in the genomic sequence of promoter structures of genes or genomic loci of genes participating in the pathway, in SNPs in the genomic sequence of genes or genomic loci of genes participating in the pathway, in SNPs in associated regions, in intron sequences, in intron-exon-border sequences etc. associated with genes or genomic loci of genes participating in the pathway, or in copy numbers or copy number effects associated with genes or genomic loci of genes participating in the pathway etc. Further envisaged alterations are the alterations as mentioned herein above, including copy number differences, mutations etc.

The present invention envisages the markers in any suitable form or format, e.g. in the form of genetic units, for instance as genes, or in the form of expressed units, e.g. as transcripts, proteins or derivatives thereof. Also envisaged are genomic marker features, e.g. the genomic sequence of the genes or genomic loci of genes participating in the pathway, the genomic sequence of promoter structures of genes or genomic loci of genes participating in the pathway, SNPs in the genomic sequence of genes or genomic loci of genes participating in the pathway, SNPs in associated regions, intron sequences, intron-exon-border sequences etc. associated with genes or genomic loci of genes participating in the pathway, copy number effects associated with genes or genomic loci of genes participating in the pathway. Said genes or corresponding genomic loci may be addressed independently or as a subgroup of all genes or corresponding genomic loci participating in a pathway, or all or essentially all genes or corresponding genomic loci participating in a pathway may be addressed. Furthermore, the marker may comprise secondary binding elements, such as an antibody, a binding ligand, siRNA or antisense RNA molecules specific for the marker transcript. The marker may also comprise epigenetic modifications within the genes or genomic loci of genes participating in the pathway etc, e.g. methylated forms of the genes or genomic loci of genes participating in the pathway, hypomethylated forms of the genes or genomic loci of genes participating in the pathway, methylation states in DNA or histones associated the genes or genomic loci of genes participating in the pathway etc.

In one embodiment of the present invention, the group of markers comprises at least the altered endothelins pathway, the altered ceramide signaling pathway and the altered rapid glucocorticoid signaling pathway. In a further embodiment of the present invention the group of markers comprises at least the altered endothelins pathway, the altered rapid glucocorticoid signaling pathway and the altered paxillin-independent events mediated by a4b1 and a4b7 pathway. In a further embodiment of the present invention the group of markers comprises at least the altered endothelins pathway, the altered paxillin-independent events mediated by a4b1 and a4b7 pathway and the altered osteopontin-mediated events pathway. In a further embodiment of the present invention the group of markers comprises at least the altered endothelins pathway, the altered osteopontin-mediated events pathway and the altered IL6 mediated signaling events pathway. In yet another embodiment of the present invention the group of markers comprises at least the altered endothelins pathway, the altered IL6 mediated signaling events pathway and the altered regulation of telomerase pathway. In yet another embodiment of the present invention the group of markers comprises at least the altered endothelins pathway, the altered regulation of telomerase pathway and the altered JNK signaling in the CD4+TCR pathway. In yet another embodiment of the present invention the group of markers comprises at least the altered endothelins pathway, the altered JNK signaling in the CD4+TCR pathway and the altered PLK2 and PLK4 events pathway. In yet another embodiment of the present invention the group of markers comprises at least the altered endothelins pathway, the altered PLK2 and PLK4 events pathway and the altered EPO signaling pathway. In yet another embodiment of the present invention the group of markers comprises at least the altered endothelins pathway, the altered EPO signaling pathway and the altered p53 pathway. In yet another embodiment of the present invention the group of markers comprises at least the altered endothelins pathway, the altered p53 pathway and the altered signaling events mediated by VEGFR1 and VEGFR2 pathway. In yet another embodiment of the present invention the group of markers comprises at least the altered endothelins pathway, the altered signaling events mediated by VEGFR1 and VEGFR2 pathway and the altered VEGFR1 specific signals pathway. In a further embodiment of the present invention the group of markers comprises at least the altered endothelins pathway, the altered VEGFR1 specific signals pathway and the altered Syndecan-1-mediated signaling events pathway.

In a further embodiment of the present invention, the group of markers comprises at least the altered ceramide signaling pathway, the altered rapid glucocorticoid signaling pathway and the altered paxillin-independent events mediated by a4b1 and a4b7 pathway. In a further embodiment of the present invention, the group of markers comprises at least the altered rapid glucocorticoid signaling pathway, the altered paxillin-independent events mediated by a4b1 and a4b7 pathway and the altered osteopontin-mediated events pathway. In a further embodiment of the present invention, the group of markers comprises at least the altered paxillin-independent events mediated by a4b1 and a4b7 pathway, the altered osteopontin-mediated events pathway and the altered IL6 mediated signaling events pathway. In a further embodiment of the present invention, the group of markers comprises at least the altered osteopontin-mediated events pathway, the altered IL6 mediated signaling events pathway and the altered regulation of Telomerase pathway. In a further embodiment of the present invention, the group of markers comprises at least the altered IL6 mediated signaling events pathway and the altered regulation of Telomerase pathway and the altered JNK signaling in the CD4+TCR pathway. In a further embodiment of the present invention, the group of markers comprises at least the altered regulation of Telomerase pathway and the altered JNK signaling in the CD4+TCR pathway and the altered PLK2 and PLK4 events pathway. In a further embodiment of the present invention, the group of markers comprises at least the altered JNK signaling in the CD4+TCR pathway and the altered PLK2 and PLK4 events pathway and the altered EPO signaling pathway. In a further embodiment of the present invention, the group of markers comprises at least the altered PLK2 and PLK4 events pathway and the altered EPO signaling pathway and the altered p53 pathway. In a further embodiment of the present invention, the group of markers comprises at least the altered EPO signaling pathway and the altered p53 pathway and the altered signaling events mediated by VEGFR1 and VEGFR2 pathway. In a further embodiment of the present invention, the group of markers comprises at least the altered p53 pathway, the altered signaling events mediated by VEGFR1 and VEGFR2 pathway and the altered VEGFR1 specific signals pathway. In a further embodiment of the present invention, the group of markers comprises at least the altered signaling events mediated by VEGFR1 and VEGFR2 pathway, the altered VEGFR1 specific signals pathway and the altered Syndecan-1-mediated signaling events pathway.

In a further preferred embodiment of the present invention, the group of markers comprises at least the altered signaling events mediated by VEGFR1 and VEGFR2 pathway. In yet another embodiment of the present invention the group of markers comprises at least the altered signaling events mediated by VEGFR1 and VEGFR2 pathway and the altered endothelins pathway. In yet another embodiment of the present invention the group of markers comprises at least the altered signaling events mediated by VEGFR1 and VEGFR2 pathway and the altered ceramide signaling pathway. In yet another embodiment of the present invention the group of markers comprises at least the altered signaling events mediated by VEGFR1 and VEGFR2 pathway and the altered rapid glucocorticoid signaling pathway. In yet another embodiment of the present invention the group of markers comprises at least the altered signaling events mediated by VEGFR1 and VEGFR2 pathway and the altered paxillin-independent events mediated by a4b1 and a4b7 pathway. In yet another embodiment of the present invention the group of markers comprises at least the altered signaling events mediated by VEGFR1 and VEGFR2 pathway and the altered osteopontin-mediated events pathway. In yet another embodiment of the present invention the group of markers comprises at least the altered signaling events mediated by VEGFR1 and VEGFR2 pathway and the altered IL6 mediated signaling events pathway. In yet another embodiment of the present invention the group of markers comprises at least the altered signaling events mediated by VEGFR1 and VEGFR2 pathway and the altered regulation of telomerase pathway. In yet another embodiment of the present invention the group of markers comprises at least the altered signaling events mediated by VEGFR1 and VEGFR2 pathway and the altered JNK signaling in the CD4+TCR pathway. In yet another embodiment of the present invention the group of markers comprises at least the altered signaling events mediated by VEGFR1 and VEGFR2 pathway and the altered PLK2 and PLK4 events pathway. In yet another embodiment of the present invention the group of markers comprises at least the altered signaling events mediated by VEGFR1 and VEGFR2 pathway and the altered EPO signaling pathway. In yet another embodiment of the present invention the group of markers comprises at least the altered signaling events mediated by VEGFR1 and VEGFR2 pathway and the altered p53 pathway. In yet another embodiment of the present invention the group of markers comprises at least the altered signaling events mediated by VEGFR1 and VEGFR2 pathway and the altered VEGFR1 specific signals pathway. In yet another embodiment of the present invention the group of markers comprises at least the altered signaling events mediated by VEGFR1 and VEGFR2 pathway and the altered Syndecan-1-mediated signaling events pathway.

In a further embodiment of the present invention, the group of markers comprises the altered signaling events mediated by VEGFR1 and VEGFR2 pathway and 2, 3, 4, 5, 6, 7, 8 or more of the markers of Table 1. In yet another embodiment of the present invention the group of markers comprises the altered endothelins pathway and 3, 4, 5, 6, 7, 8 or more of the markers of Table 1. In yet another embodiment of the present invention the group of markers comprises the altered ceramide signaling pathway and 2, 3, 4, 5, 6, 7, 8 or more of the markers of Table 1. In yet another embodiment of the present invention the group of markers comprises the altered rapid glucocorticoid signaling pathway and 2, 3, 4, 5, 6, 7, 8 or more of the markers of Table 1. In yet another embodiment of the present invention the group of markers comprises the altered paxillin-independent events mediated by a4b1 and a4b7 pathway and 2, 3, 4, 5, 6, 7, 8 or more of the markers of Table 1. In yet another embodiment of the present invention the group of markers comprises the altered osteopontin-mediated events pathway and 2, 3, 4, 5, 6, 7, 8 or more of the markers of Table 1. In yet another embodiment of the present invention the group of markers comprises the altered IL6 mediated signaling events pathway and 2, 3, 4, 5, 6, 7, 8 or more of the markers of Table 1. In yet another embodiment of the present invention the group of markers comprises the altered regulation of telomerase pathway and 2, 3, 4, 5, 6, 7, 8 or more of the markers of Table 1. In yet another embodiment of the present invention the group of markers comprises the altered JNK signaling in the CD4+TCR pathway and 2, 3, 4, 5, 6, 7, 8 or more of the markers of Table 1. In yet another embodiment of the present invention the group of markers comprises the altered PLK2 and PLK4 events pathway and 2, 3, 4, 5, 6, 7, 8 or more of the markers of Table 1. In yet another embodiment of the present invention the group of markers comprises the altered EPO signaling pathway and 2, 3, 4, 5, 6, 7, 8 or more of the markers of Table 1. In yet another embodiment of the present invention the group of markers comprises the altered p53 pathway and 2, 3, 4, 5, 6, 7, 8 or more of the markers of Table 1. In yet another embodiment of the present invention the group of markers comprises the altered signaling events mediated by VEGFR1 and VEGFR2 pathway and 2, 3, 4, 5, 6, 7, 8 or more of the markers of Table 1. In yet another embodiment of the present invention the group of markers comprises the altered VEGFR1 specific signals pathway and 2, 3, 4, 5, 6, 7, 8 or more of the markers of Table 1. In yet another embodiment of the present invention the group of markers comprises the altered Syndecan-1-mediated signaling events pathway and 2, 3, 4, 5, 6, 7, 8 or more of the markers of Table 1.

In a further aspect the present invention relates to a method of diagnosis in vitro or in vivo of a medical condition, e.g. a cancer disease, preferably ovarian cancer, wherein said method is based on the determination of one or more molecular parameters linked to the marker as defined above, e.g. a marker or group of markers comprising at least 1, 2, 3, 4, 5, 6, 7, 8, 9, 10, 11, 12, 13 or all markers of Table 1. Preferably, the method of diagnosis comprises the determination of presence or absence or amount/level of an expression product (e.g. protein, transcript etc.) of one or more of the markers, e.g. one, more or all pathway members according to the information provided in Table 1. In addition or alternatively, the determination of further parameters such as an alteration in the genomic sequence of the genes or genomic loci of genes participating in the pathway, an alteration in the genomic sequence of promoter structures of genes or genomic loci of genes participating in the pathway, an alteration in one or more SNPs in the genomic sequence of genes or genomic loci of genes participating in the pathway, an alteration in one or more SNPs in associated regions, an alteration in intron sequences, in intron-exon-border sequences etc. associated with genes or genomic loci of genes participating in the pathway, or an alteration in in copy numbers or copy number effects associated with genes or genomic loci of genes participating in the pathway etc. may be carried out.

In a further aspect the present invention relates to a composition for in vivo or in vitro diagnosing, detecting, monitoring or prognosticating a medical condition, preferably a cancer disease, more preferably ovarian cancer, or for diagnosing, detecting, monitoring or prognosticating the likelihood of responsiveness of a subject to a cancer therapy, preferably the therapy against ovarian cancer, more preferably a platinum drug based therapy, comprising a nucleic acid affinity ligand and/or a peptide affinity ligand for the expression product(s) or protein(s) of the above mentioned marker or group of markers. Such a composition may alternatively or additionally comprise an antibody against any of the above mentioned markers, e.g. against one, more or all pathway members according to the information provided in Table 1. In a preferred embodiment of the present invention said nucleic acid affinity ligand or peptide affinity ligand is modified to function as an imaging contrast agent.

The term “diagnosing a medical condition” as used herein means that a subject may be considered to be suffering from a medical condition or disease, preferably cancer, more preferably ovarian cancer, when one more of the pathways as indicated herein above, e.g. in Table 1, or one or more the members of said pathways are altered, e.g. show an altered expression behavior or pattern or other molecular parameter alterations etc. as described herein above in comparison to a healthy or normal cell or subject as defined herein. The term “diagnosing” also refers to the conclusion reached through that comparison process.

The term “diagnosing the likelihood of responsiveness of a subject to a cancer therapy” as used herein means that a subject may be considered to potentially respond to cancer therapy, preferably ovarian cancer therapy, when one more of the pathways as indicated herein above, e.g. in Table 1, or one or more the members of said pathways are altered, e.g. show an altered expression behavior or pattern or other molecular parameter alterations etc. as described herein above in comparison to a healthy or normal as defined herein.

The term “detecting a medical condition” as used herein means that the presence of a medical condition, disease or disorder in an organism, preferably of a cancer disease, more preferably of ovarian cancer may be determined or that such a disease or disorder may be identified in an organism, preferably in a human being. The determination or identification of a medical condition, disease or disorder may be accomplished by a comparison of the altered expression behavior or pattern or other molecular parameter alterations etc. as described herein above in comparison to a healthy or normal cell or subject as defined herein. In a preferred embodiment of the present invention an ovarian cancer disease may be detected if the expression level and/or genomic alterations of a patient are similar or identical to corresponding parameters of an established, e.g. independently established, ovarian cancer cell or cell line.

The term “detecting the likelihood of responsiveness of a subject to a cancer therapy” as used herein means a subject may be considered to potentially respond to cancer therapy. This detection may be accomplished by a comparison of the altered expression behavior or pattern or other molecular parameter alterations etc. as described herein above in comparison to a healthy or normal cell or subject as defined herein.

The term “monitoring a medical condition” as used herein relates to the accompaniment of a diagnosed or detected medical condition, disease or disorder, preferably of a cancer disease, more preferably of ovarian cancer, e.g. during a treatment procedure or during a certain period of time, typically during 2 months, 3 months, 4 months, 6 months, 1 year, 2 years, 3 years, 5 years, 10 years, or any other period of time. The term “accompaniment” means that a medical condition, disease and, in particular, changes of sates of said medical condition or disease may be detected by comparing the expression level and/or molecular parameters as defined herein to corresponding parameters of normal or healthy cells or subjects in any type of periodical time segment, e.g. every week, every 2 weeks, every month, every 2, 3, 4, 5, 6, 7, 8, 9, 10, 11 or 12 month, every 1.5 year, every 2, 3, 4, 5, 6, 7, 8, 9 or 10 years, during any period of time, e.g. during 2 weeks, 3 weeks, 1, 2, 3, 4, 5, 6, 7, 8, 9, 10, 11, 12 months, 1.5, 2, 3, 4, 5, 6, 7, 8, 9, 10, 15 or 20 years, respectively. The monitoring may also include the detection of the expression of additional genes or molecular parameters, e.g. of housekeeping genes.

The term “monitoring the likelihood of responsiveness of a subject to a cancer therapy” as used herein relates to the accompaniment of a diagnosed or detected likelihood of responsiveness of a subject to a cancer therapy, more preferably a cancer therapy against ovarian cancer, e.g. during a treatment procedure or during a certain period of time, typically during 2 months, 3 months, 4 months, 6 months, 1 year, 2 years, 3 years, 5 years, 10 years, or any other period of time.

The term “prognosticating a medical condition” as used herein refers to the prediction of the course or outcome of a diagnosed or detected medical condition or disease, e.g. cancer disease, preferably ovarian cancer disease, e.g. during a certain period of time, during a treatment or after a treatment, e.g. a platinum based drug therapy. The term also refers to a determination of chance of survival or recovery from the disease, as well as to a prediction of the expected survival time of a subject. A prognosis may, specifically, involve establishing the likelihood for survival of a subject during a period of time into the future, such as 6 months, 1 year, 2 years, 3 years, 5 years, 10 years or any other period of time.

The term “prognosticating the likelihood of responsiveness of a subject to a cancer therapy” as used herein refers to the prediction of the course or outcome of a cancer therapy with regard to the responsiveness of a subject thereto, e.g. during a certain period of time, during a treatment or after a treatment. A prognosis may, specifically, involve establishing the likelihood of responsiveness of a subject to a cancer therapy during a period of time into the future, such as 6 months, 1 year, 2 years, 3 years, 5 years, 10 years or any other period of time.

Further envisaged is a method of identifying a subject for eligibility for a cancer disease therapy, comprising:

(a) testing in a sample obtained from subject for a parameter associated with a marker or group of markers as indicated herein above;

(b) classifying the levels of tested parameters; and

(c) identifying the individual as eligible to receive a cancer disease therapy where the subject's sample is classified as having an altered pathway according to the information provided in Table 1, or as defined herein above. Preferably, said cancer disease is ovarian cancer. More preferably said cancer disease therapy is a platinum based drug cancer therapy.

In another aspect the present invention relates to an assay for detecting, diagnosing, graduating, monitoring or prognosticating a medical condition, preferably cancer, more preferably ovarian cancer, comprising at least the steps of

(a) testing in a sample obtained from a subject for the alteration of a stratifying biomedical marker or group of markers as defined herein above, e.g. in Table 1;

(b) testing in a control sample for alterations of the same marker or group of markers as in (a);

(c) determining the difference in alterations of markers of steps (a) and (b); and

(d) deciding on the presence or stage of a medical condition or the responsiveness of a subject to a therapy against said medical condition based on the results obtained in step (c).

In yet another aspect the present invention relates to an assay for detecting, diagnosing, graduating, monitoring or prognosticating the responsiveness of a subject to a therapy against said medical condition, preferably cancer, more preferably ovarian cancer, comprising at least the steps of

(a) testing in a sample obtained from a subject for the alteration of a stratifying biomedical marker or group of markers as defined herein above, e.g. in Table 1;

(b) testing in a control sample for alterations of the same marker or group of markers as in (a);

(c) determining the difference in alterations of markers of steps (a) and (b); and

(d) deciding on the responsiveness of a subject to a therapy against said medical condition based on the results obtained in step (c). In a preferred embodiment said therapy is a cancer therapy based on a platinum based drug. More preferably, it is an ovarian cancer therapy based on a platinum based drug.

The term “alteration” as used in the context of the above described assays includes alterations of parameters such as expression and/or alterations of further parameters such as genomic indicators, e.g. SNPs, mutations, methylation pattern etc. as described herein above. Further, non limiting examples of such parameters are, the presence or absence or amount/level of truncated transcripts, truncated proteins, the presence or absence or amount/level of cellular markers, the presence or absence or amount/level of surface markers, the presence or absence or amount/level of glycosylation pattern, the form of said pattern, the presence or absence of expression pattern on mRNA or protein level, the form of said pattern, cell sizes, cell behavior, growth and environmental stimuli responses, motility, the presence or absence or amount/level of histological parameters, staining behavior, the presence or absence or amount/level of biochemical or chemical markers, e.g. peptides, secondary metabolites, small molecules, the presence or absence or amount/level of transcription factors, and the presence or absence of further biochemical or genetic markers, e.g. the expression or methylation of markers or pathway members not comprised in the pathways indicated in Table 1.

In a further specific embodiment of the present invention the expression may be tested by any suitable means known to the person skilled in the art, preferably by room temperature polymerase chain reaction (RT-PCR), RNA sequencing, or gene expression detection on microarrays. In yet another specific embodiment the methylation state or methylation pattern may be determined by using methylation specific PCR (MSP), bisulfite sequencing, the employment of microarray techniques, direct sequencing, such as, for example, implemented by Pacific Biosciences(R). Further detection methods for genomic alterations, sequence alterations etc. have been described herein or would be known to the person skilled in the art. These methods are also encompassed and envisaged by the present invention.

In another aspect the present invention relates to a clinical decision support system comprising:

an input for providing datasets comprising one or more sets of molecular data from a patient;

a computer program product for enabling a processor to carry out a method according to the present invention as defined herein above or below, and a computer program product for quantifying the degree of alteration of information flow of a biological network in said patient; and

an output for outputting the assignment of a patient to a clinically relevant group.

In a specific embodiment the dataset to be used as input may comprise data on one or more of the markers as mentioned herein above, e.g. 1, 2, 3, 4, 5, 6, 7, 8, 9, 10, 11, 12, 13 or all markers selected from an altered endothelin pathway, an altered ceramide signaling pathway, an altered rapid glucocorticoid signaling pathway, an altered paxilin independent a4b1 and a4b7 pathway, an altered osteopontin pathway, an altered IL6 signaling pathway, an altered telomerase pathway, an altered JNK signaling pathway in the CD4+TCR pathway, an altered PLK2- and PLK4-pathway, an altered EPO-signaling pathway, an altered p53-pathway, an altered VEGFR1- and VEGFR-2 signaling pathway, an altered VEGFR1-specific pathway, and an altered syndecan-1 signaling pathway as indicated in Table 1, or any of the maker combinations as defined herein above. E.g. a subject to be tested may specifically be tested for one or more of the mentioned markers, or the group of markers as defined above, i.e. corresponding data sets may be obtained. In a further specific embodiment said dataset as mentioned above may be used in the ambit of cancer diagnosis, more preferably in the ambit of diagnosis of ovarian cancer.

In a specific embodiment said medical decision support system may be a molecular oncology decision making workstation. The decision making workstation may preferably be used for deciding on the initiation and/or continuation of a cancer therapy for a subject or patient. More preferably, the decision making workstation may be used for deciding on the probability and likelihood of responsiveness to a platinum based therapy.

In a further aspect the present invention also envisages a software or computer program to be used on a decision making workstation. The software may, for example, be based on an implementation of one, more or all method steps as defined herein above, and/or on the analysis of datasets or data linked to the marker or group of markers defined above, e.g. 1, 2, 3, 4, 5, 6, 7, 8, 9, 10, 11, 12, 13 or all markers selected from an altered endothelin pathway, an altered ceramide signaling pathway, an altered rapid glucocorticoid signaling pathway, an altered paxilin independent a4b1 and a4b7 pathway, an altered osteopontin pathway, an altered IL6 signaling pathway, an altered telomerase pathway, an altered JNK signaling pathway in the CD4+TCR pathway, an altered PLK2- and PLK4-pathway, an altered EPO-signaling pathway, an altered p53-pathway, an altered VEGFR1- and VEGFR-2 signaling pathway, an altered VEGFR1-specific pathway, and an altered syndecan-1 signaling pathway as indicated in Table 1, or any of the maker combinations as defined herein above.

In a particularly preferred embodiment of the present invention said assignment of a patient to a clinically relevant groups in the context of the output feature of the above defined clinical decision support system may be visualized in the context of the information flow in the networks and other clinically relevant groups or healthy subjects.

In a further preferred embodiment said assignment of a patient to a clinically relevant group may be visualized in the context of the information flow in the networks and other clinically relevant groups and healthy subjects.

Such visualization may be implemented with suitable algorithms known to the person skilled in the art.

Furthermore, said visualization may be combined with additional diagnostic tools or visualizations, e.g. in an integrated decision support system.

For use at the bedside said clinical decision support system may be provided in the form of an electronic picture/data archiving and communication system. Examples of such electronic picture/data archiving and communication systems are PACS systems. Particularly preferred are iSite PACS systems, as provided by Philips. These systems may be adjusted or modified in order to comply with the requirements of the methods of the present invention and/or in order to be able to carry out a computer program or algorithm as described herein, and/or in order to store expression or other molecular parameters or patient data or parts of patient databases as defined herein

The following example and figures are provided for illustrative purposes. It is thus understood that the example and figures are not to be construed as limiting. The skilled person in the art will clearly be able to envisage further modifications of the principles laid out herein.

### EXAMPLES

### Example 1

### Analysis of Ovarian Cancer Molecular Profiling Data

The method of the present invention was tested in the context of ovarian cancer molecular profiling data from The Cancer Genome Atlas. The pathways used in the analysis were chosen from the NCI-Pathway Interaction Database (NCI-PID). Other databases such as the KEGG pathway database provide similar information and can also or additionally be used for obtaining pathway information.

Using a total of 123 patients who were treated with platinum-based chemotherapy, the number of days the patients survived without disease progression since the start of therapy were determined. This period is defined to be Platinum Free Interval (PFI) and is a clinically important measure of therapy response of ovarian cancer patients to platinum-based chemotherapy. A total of 135 pathways were chosen from the NCI-PID.

Based on the method according to the present invention, the 123 patients were clustered into subgroups based on the pathway information flow in all the pathways in the database.

Pathways that stratified patients into subgroups with significantly different Platinum-Free Intervals were subsequently chosen to be important for PFI prediction.

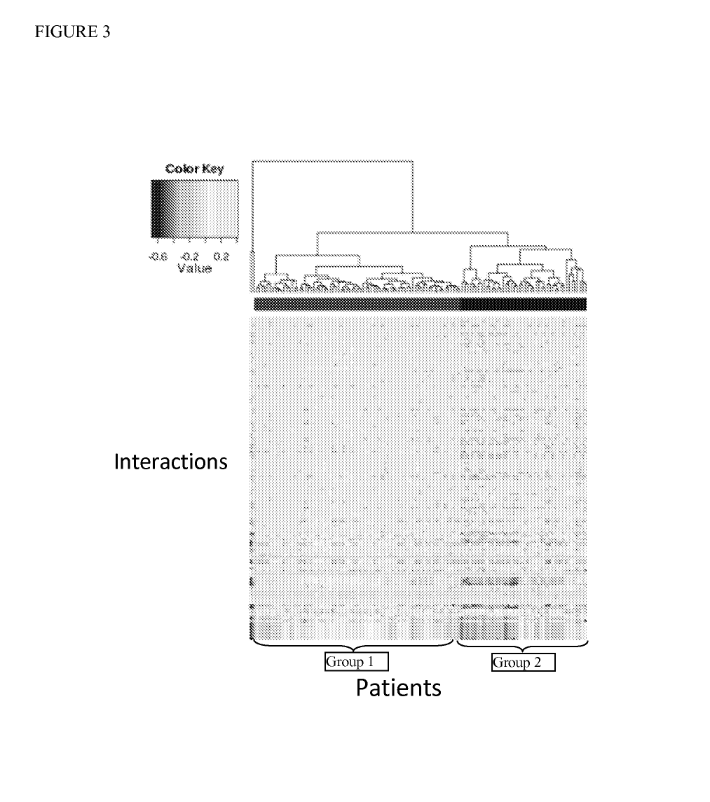

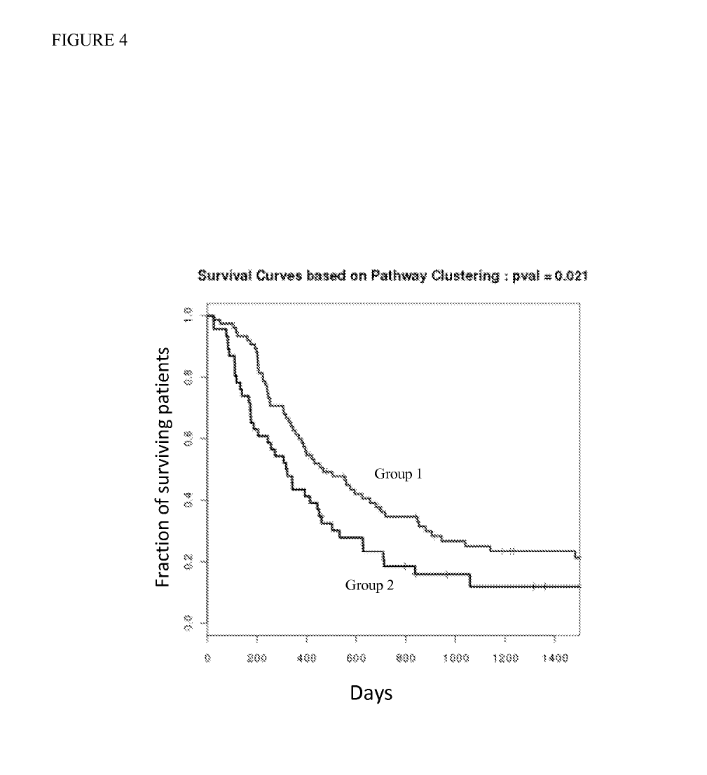

For example, the pathway named “Signaling Events Mediated by VEGFR1 and VEGFR2” was able to distinguish two groups of patients with significantly different survival rates as is shown in FIGS. 3 and 4.

The survival curves were plotted using the Kaplan-Meier estimator. The Kaplan-Meier estimator calculates the probability of no adverse event at any given time by using the time to adverse event for all the patients included in the study. Since some patients typically leave the study after a while, the Kaplan-Meier estimator accounts for the loss of patients from the study at different points in time due to lack of follow-up. This so-called “censoring problem” in survival analysis is already accounted for in the Kaplan-Meier estimator. The Kaplan-Meier estimator was used to estimate the probability of ovarian cancer progression or recurrence after platinum therapy. The statistical significance was evaluated using the log-rank or Mantel-Haenszel test of the difference in Kaplan-Meier curves. It was, in particular, checked for statistically significant differences between the two Kaplan-Meier estimates for the two groups of patients. A statistical significance (p-value) of at least 0.05 or lower is considered as potentially a good marker for stratification of patients into good and poor responding groups. The predictions based on significant pathways can also be combined using voting schemes or linear classifiers in order to improve the specificity of the predictions. For example, if a majority of the significant pathways classified a given patient as a good responder, one could place that patient into the good responder group.

Pathways which were shown to be able to stratify patients into groups with significantly different platinum free survival are provided in the following Table 2.

TABLE 2

| Pathway Name | P-value |
|---|---|
| endothelins | 0.0007 |
| ceramide signaling pathway | 0.002 |
| rapid glucocorticoid signaling | 0.003 |
| paxillin-independent events mediated by a4b1 and | 0.003 |
| a4b7 | |
| osteopontin-mediated events | 0.004 |
| IL6 mediated signaling events | 0.005 |
| regulation of telomerase | 0.01 |
| JNK signaling in the CD4+TCR pathway | 0.01 |
| PLK2 and PLK4 events | 0.02 |
| EPO Signaling pathway | 0.02 |
| p53 pathway | 0.02 |
| signaling events mediated by VEGFR1 and VEGFR2 | 0.02 |
| VEGFR1 specific signals | 0.03 |
| syndecan-1-mediated signaling events | 0.04 |

1. A method for stratifying a patient into a clinically relevant group, comprising with a computer performing the steps of:
obtaining datasets comprising one or more sets of molecular data from a patient sample;
identifying the probability of an alteration within the one or more sets of molecular data in comparison to a database of molecular data of known phenotypes, preferably molecular data of the expression of one or more of the patient's genes;
inferring the activity of a biological network on the basis of said probabilities;
identifying a network information flow probability for said patient via the probability of interactions in said network based on said probability of altered molecular data;
creating multiple instances of network information flow vectors for said patient sample by sampling from a full interaction probability distribution of the biological network;
calculating the distance of said patient from other subjects in a patient database using the multiple instances of network information flow vectors; and
assigning said patient to a clinically relevant group based on the outcome of the previous step.

2. The method of claim 1, wherein said molecular data comprise data on nonsense mutations, single nucleotide polymorphisms (SNP), copy number variations (CNV), splicing variations, variations of a regulatory sequence, small deletions, small insertions, small indels, gross deletions, gross insertions, complex genetic rearrangements, inter chromosomal rearrangements, intra chromosomal rearrangements, loss of heterozygosity, insertion of repeats, deletion of repeats, DNA methylation, histone methylation or acetylation states, gene and/or non-coding RNA expression and/or chromatin precipitation data revealing DNA binding sites or regions, preferably obtained by genome sequencing, immunohistochemistry, FISH, PCR-techniques and/or microarray-techniques.

3. The method of claim 1, wherein said comparison to a database of molecular data of known phenotypes is a comparison to a biological annotation database, a pathway database, a database on biological processes and/or a database on biological functions, preferably the National Cancer Institute Pathway interaction database, the KEGG pathway database, the BioCarta database, the Panther database, the Reactome database, and/or the DAVID database.

4. The method of claim 3, wherein the probability of an alteration within the one or more sets of molecular data is identified by estimating altered expression levels of individual genes in the network by integrating said molecular data using a probabilistic graphical model framework, preferably factor graphs.

5. The method of claim 3, wherein the probability of an alteration within the one or more sets of molecular data is identified by estimating altered copy number levels, altered methylation states, or altered gene function due to mutations of genomic loci or genomic regions in the network by integrating said molecular data using a probabilistic graphical model framework, preferably factor graphs.

6. The method of claim 1, wherein said interactions are interactions for genes or genomic loci with molecular alterations, preferably genes or genomic loci belonging to biological networks as defined in a pathway database.

7. The method of claim 1, wherein said creation of multiple instances of network information flow vectors is used for the generation of a distribution of sample information flow vectors, representing the information flow in a network for said patient.

8. The method of claim 7, wherein said distance of said patient from other subjects is calculated as the average of pairwise distance of sample information flow vectors in a given network.

9. The method of claim 8, wherein said pairwise distance of sample information flow vectors is calculated as the Euclidean distance between the sample information flow vectors in a given network, or as a weighted Euclidean distance, wherein the weights for each entry in the information flow vector are proportional to the depth of that interaction in the given network.

10. The method of claim 1, wherein said assignment of said patient to a clinically relevant group is performed with a clustering algorithm based on the pairwise distances of said patient with one, more or all subjects in a patient database.

11. The method of claim 1, wherein said patient database is a disease related database, preferably a cancer disease related database.

12. The method of claim 1, wherein said clinically relevant group is associated with a cancerous disease, preferably ovarian cancer, breast cancer, or prostate cancer, or with the likelihood of recurrence of a cancerous disease in a subject after a therapy, or wherein said clinically relevant group is associated with the likelihood of responsiveness of a subject to a therapy comprising one or more platinum based drugs.

13. A biomedical marker or group of biomedical markers for use in performing the method of claim 12 said biomedical marker or group of biomedical markers comprising at least 3, 4, 5, 6, 7, 8, 9, 10, 11, 12, 13 or all markers selected from an altered endothelin pathway, an altered ceramide signaling pathway, an altered rapid glucocorticoid signaling pathway, an altered paxilin independent a4b1 and a4b7 pathway, an altered osteopontin pathway, an altered ILE signaling pathway, an altered telomerase pathway, an altered JNK signaling pathway in the CD4+TCR pathway, an altered PLK2- and PLK4-pathway, an altered EPO-signaling pathway, an altered p53-pathway, an altered VEGFR1- and VEGFR-2 signaling pathway, an altered VEGFR1-specific pathway, and an altered syndecan-1 signaling pathway, indicated in Table 1.

14. An assay for detecting, diagnosing, graduating, monitoring or prognosticating a medical condition, or for detecting, diagnosing, monitoring or prognosticating the responsiveness of a subject to a therapy against said medical condition, preferably cancer, more preferably ovarian cancer, comprising at least the steps of
(a) testing in a sample obtained from a subject for the alteration of a stratifying biomedical marker or group of biomedical markers as defined in claim 13;
(b) testing in a control sample for alterations of the same marker or group of markers as in (a);
(c) determining the difference in alterations of markers of steps (a) and (b); and
(d) deciding on the presence or stage of a medical condition or the responsiveness of a subject to a therapy against said medical condition, preferably cancer, more preferably ovarian cancer, based on the results obtained in step (c).

15. A clinical decision support system comprising:
an input for providing datasets comprising multi-modality molecular profiling data from a patient;
a computer program product for enabling a processor to carry out the method of claim 1 and for quantifying the degree of alteration of information flow of a biological network in said patient; and
an output for outputting the assignment of a patient to a clinically relevant group, wherein said assignment of a patient to a clinically relevant groups is preferably visualized in the context of the information flow in the networks and other clinically relevant groups and/or healthy subjects.
